(19) United States
(12) Patent Application Publication
(10) Pub. No.: US 2006/0128209 A1
(43) Pub. Date: Jun. 15, 2006

(54) Lighted booster cables

(76) Inventor: Chan Hing Chai, Hong Kong (HK)

Correspondence Address: Roy, Kiesel, Keegan & DeNicola, 2355 Drusilla Lane, Baton Rouge, LA, 70809, US

(21) Appl. No.: 11/012,625

(22) Filed: Dec. 15, 2004

(51) Int. Cl. H01R 11/00

(52) U.S. Cl. 439/504

(57) ABSTRACT

A set of booster cables for charging a depleted vehicle battery is disclosed. The booster cables have an integral lighting device designed to make the jump start procedure quicker and safer in circumstances where adequate lighting is not present.

### BACKGROUND OF THE INVENTION

1. Field of the Invention

This invention relates to devices used to charge depleted vehicle batteries in general and to lighted booster cables, in particular.

2. Prior Art

Utilizing booster cables to jump start a vehicle with a dead battery has become a common and well-practiced procedure, however, if not performed properly, the procedure can involve substantial risks. For example, in many instances, the necessity of performing the jump start procedure arises at night or in other circumstances when good lighting is not available in the vicinity of the vehicle with the depleted battery. In such cases, identification of the battery terminal and/or a ground point on this vehicle becomes difficult. As a consequence, a proper electrical connection between the source vehicle battery and the depleted vehicle battery may not be achieved. Performing the jump start procedure, when there is a lack of proper electrical connection, can cause generation of sparks, explosions, and rapid discharge of battery acid, all of which may result in serious injury to individuals and/or damage to the vehicles. In addition, even if a proper battery connection has been achieved, it may be difficult to see that the jumper cables are interfering with the fan belts, pulleys, or other moving parts of the vehicle, a problem which can lead to dangerous consequences. Aside from these specific concerns, hindrance in visibility generally makes the jump start procedure laborious and time consuming. Therefore, booster cables meeting the following objectives are desired.

### OBJECTS OF THE INVENTION

It is an object of this invention to provide improved booster cables with an integral lighting means.

It is another object of this invention to reduce the risk of injury to individuals and/or damage to vehicles when jump starting vehicles.

It is still another object of this invention to make the jump start procedure quicker and more efficient.

These and other objects of the invention shall become apparent from the ensuing figures and descriptions of the invention.

### SUMMARY OF THE INVENTION

An improved set of booster cables for charging a depleted vehicle battery is disclosed. The set comprises an electrically conductive positive cable and an electrically conductive ground cable, the cables being designed to achieve an electrical connection between a source vehicle battery and a depleted vehicle battery. The set further comprises a means of illumination. The light generated will facilitate quick and safe battery connections in jump start situations.

### BRIEF DESCRIPTION OF THE FIGURES

FIG. 1 is a perspective view of a preferred embodiment of a set of lighted booster cables showing one end of the cables connected to the battery of a source vehicle and the other end prior to the connection with the depleted battery of a vehicle.

FIG. 2 is an enlarged view of the circled area of FIG. 1.

FIG. 3 is a side view of a preferred embodiment of the invention.

FIG. 4A depicts a preferred embodiment of a clamp in the closed position.

FIG. 4B depicts a preferred embodiment of a clamp in the open position.

FIG. 5 is an exploded view of a preferred embodiment of a clamp.

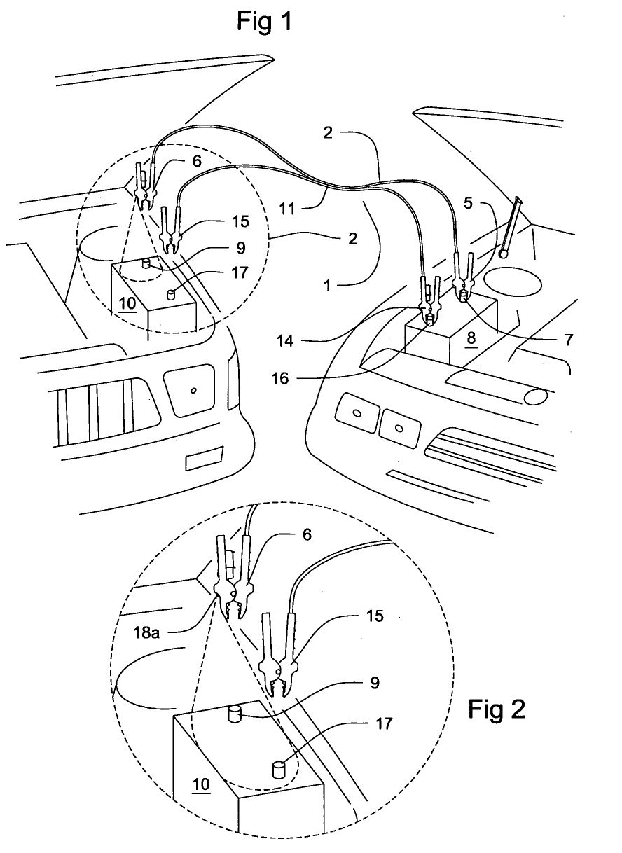

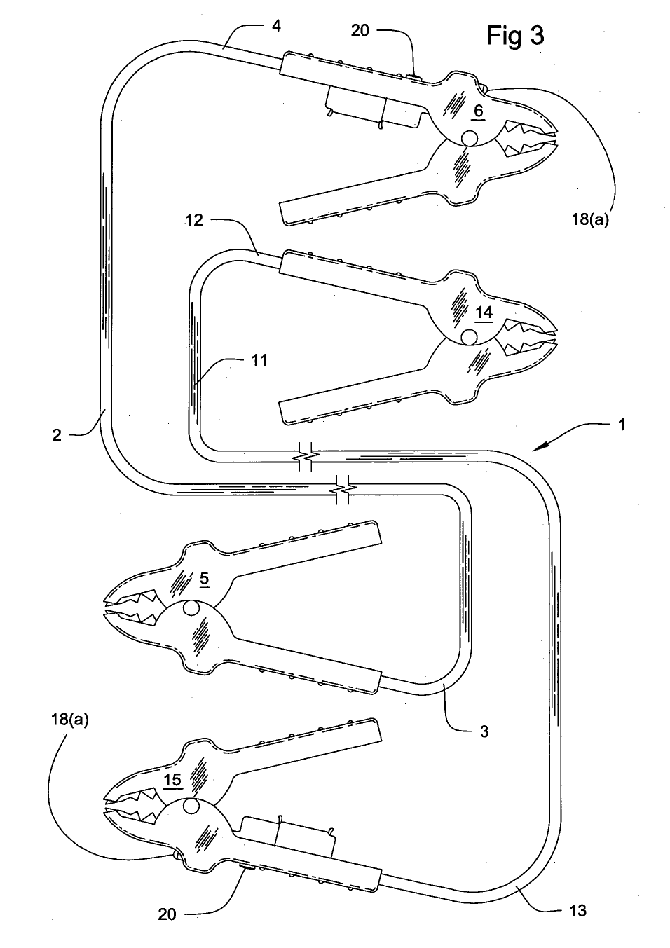

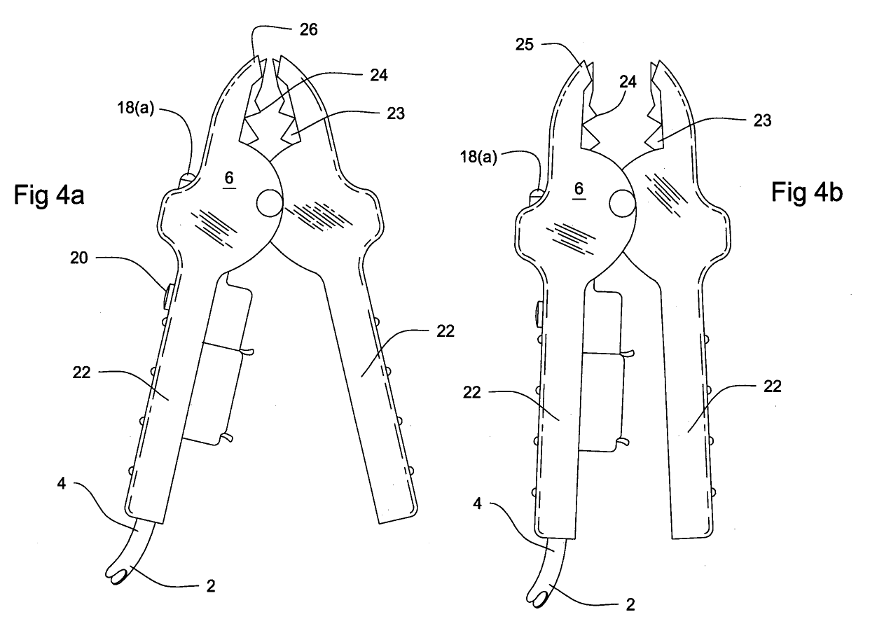

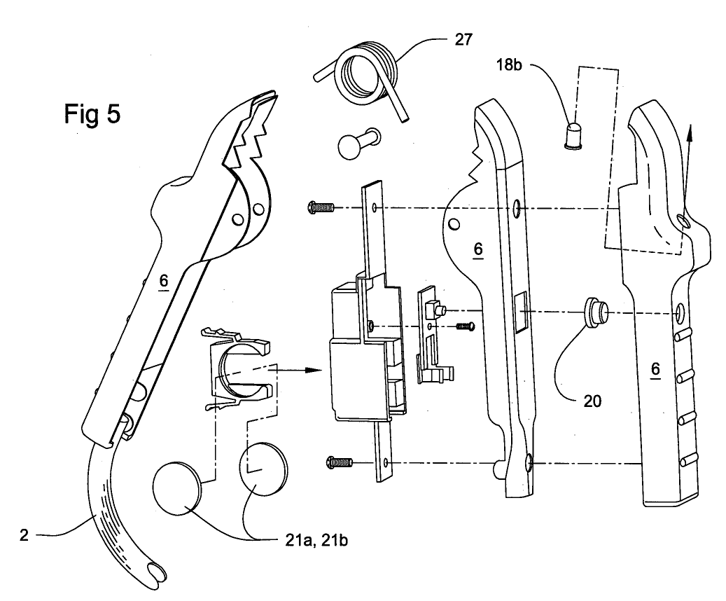

### DETAILED DESCRIPTION OF THE INVENTION

The invention comprises an improved set of booster cables 1, with a means of illumination 18a, designed to reduce the risk of injury to individuals and/or vehicles associated with exposing vehicles to jump start situations.

The preferred embodiment comprises a positive cable 2 having a first end 3 and a second end 4. Positive cable 2 should preferably be insulated and constructed of electrically conductive material, such as multiple stranded copper wire. First end 3 of positive cable 2 further comprises a first clamp 5 configured to electrically engage a positive terminal 7 of a source vehicle battery 8, and second end 4 of positive cable 2 further comprises a second clamp 6 configured to electrically engage a positive terminal 9 of a depleted vehicle battery 10. First clamp 5 and second clamp 6 each preferably further comprise a pair of arms 22 ending in a pair of jaws 23, the jaws 23 being operatively affixed to each other. Jaws 23 further comprise teeth shaped contact points 24 designed to make electrical contact with a surface. First clamp 5 and second clamp 6 should be constructed of electrically conductive material, such as copper, and the junction between first end 3 of positive cable 2 and first clamp 5, and the junction between second end 4 of positive cable 2 and second clamp 6, respectively, should be secure and electrically conductive. Furthermore, first clamp 5 and second clamp 6 of positive cable 2 should preferably be insulated, except at their respective contact points 24.

First clamp 5 and second clamp 6 further have an open position 25 and a closed position 26, respectively, and are configured to be biased against movement toward their respective open positions 25. This can be achieved by providing first clamp 5 and second clamp 6 a biasing device, preferably a spring 27 loaded hinge, such that when pressure is exerted on pair of arms 22, jaws 23 move to open position 25 and spring 27 is compressed. When pressure ceases on pair of arms 22, spring 27 relaxes to push jaws 23 back to their closed position 26.

The invention further comprises a ground cable 11. Ground cable 11 is similarly constructed to positive cable 2. Ground cable 11 is also preferably insulated and electrically conductive. Ground cable further has a first end 12 comprising an electrically conductive first clamp 14 configured to electrically engage a negative terminal 16 of source vehicle battery 8, and a second end 13 comprising an electrically conductive second clamp 15 configured to electrically engage a suitable electrical ground point 17 on the vehicle having depleted battery 10. The above discussion regarding the preferred configuration of first clamp 5 and second clamp 6 of positive cable 2 is herein incorporated by reference, as it is equally applicable to first clamp 14 and second clamp 15 of ground cable 11.

Positive cable 2 or ground cable 11, or both, will further comprise means of illumination 18a. Means of illumination 18a may be any suitable lighting device 18b. Examples include light emitting diodes or incandescent, fluorescent, and halogen bulbs. Lighting device 18b will be configured to illuminate second end 4 of positive cable 2 and/or second end 13 of ground cable 11. The light generated will assist individuals in locating positive terminal 9 of depleted vehicle battery 10 and/or suitable electrical ground point 17. In a preferred embodiment, lighting device 18b is mounted on second clamp 6 of positive cable 2 and/or second clamp 15 of ground cable 11, and comprises a switch 20 configured to turn lighting device 18b on or off. In an alternate preferred embodiment, lighting device 18b may be mounted on first clamp 5 of positive cable 2 and/or first clamp 14 of ground cable 11 if illumination under the hood of the source vehicle is required. Lighting device 18b may be powered by non-depleted battery 8 of the source vehicle; however, in a preferred embodiment, lighting device 18b is provided with a separate energy source 21a mounted on second clamp 6, of positive cable 2 and/or second clamp 15 of ground cable 11. In a preferred embodiment, separate energy source 21a is a battery 21b. In a preferred embodiment, battery 21b is a lithium cell battery.

In operation, the source vehicle should be appropriately positioned relative to the vehicle having depleted battery 10. The ignitions of both vehicles, as well as all electrical accessories on both vehicles, should then be turned off. Lighting device 18b on positive cable 2 or ground cable 11 may then be turned on to assist individuals in determining proper polarity direction so that a proper battery connection is achieved quickly and efficiently and the risk of injury to individuals and/or damage to vehicles is reduced. After proper polarity has been verified, the cables should be connected in the following order: First clamp 5 of positive cable 2 should be electrically engaged to positive terminal 7 of source vehicle battery 8. Next, second clamp 6 of positive cable 2 should then be electrically engaged to positive terminal 9 of depleted vehicle battery 10. First clamp 14 of ground cable 11 should then be electrically engaged to negative terminal 16 of source vehicle battery 8. Finally, second clamp 15 of ground cable 11 should be electrically engaged to suitable electrical ground point 17 on the vehicle having depleted battery 10. Suitable electrical ground point 17 can include the negative terminal of depleted battery 10, however for safety concerns, it is preferred that second clamp 15 be engaged to a heavy bracket, an unpainted bolt, or some other metal part of the engine block. The engine of the source vehicle should then be started to allow depleted battery 10 to begin charging. The time required for charging will differ depending on various factors, such as the outside temperature and how run down depleted battery 10 is. After depleted battery 10 has been charged for an appropriate length of time, the engine of the vehicle may then be started. Once the engine is running, the jumper cables should then be removed in an order opposite to which they were connected.

While the invention has been described in terms of its preferred embodiment, other embodiments will be apparent to those of skill in the art from a review of the foregoing. Those embodiments as well as the preferred embodiments are intended to be encompassed by the scope and spirit of the following claims.

I claim:

1. A set of lighted booster cables, comprising:
a.) an electrically conductive positive cable having a first end and a second end, wherein the first end of the positive cable further comprises an electrically conductive first clamp, wherein the second end of the positive cable further comprises an electrically conductive second clamp, wherein the first clamp is configured to electrically engage a positive terminal of a source vehicle battery, and the second clamp is configured to electrically engage a positive terminal of a depleted vehicle battery;
b.) an electrically conductive ground cable having a first end and a second end, wherein the first end of the ground cable further comprises an electrically conductive first clamp, wherein the second end of the ground cable further comprises an electrically conductive second clamp, wherein the first clamp is configured to electrically engage a negative terminal of a source vehicle battery, and the second clamp is configured to electrically engage a suitable electrical ground point; and
c.) wherein the positive cable further comprises a lighting device.

2. A set of lighted booster cables according to claim 1, wherein the lighting device is configured to illuminate the second end of the positive cable.

3. A set of lighted booster cables according to claim 2, wherein the lighting device is mounted on the second clamp of the positive cable.

4. A set of lighted booster cables according to claim 3, wherein the lighting device comprises a light emitting diode.

5. A set of lighted booster cables according to claim 4, wherein the lighting device further comprises a switch configured to turn the lighting device on or off.

6. A set of lighted booster cables according to claim 5, wherein the lighting device further comprises an energy source.

7. A set of lighted booster cables according to claim 6, wherein the energy source comprises a battery.

8. A set of lighted booster cables according to claim 7, wherein the positive cable and the ground cable are insulated.

9. A set of lighted booster cables according to claim 1, wherein the lighting device is mounted on the second clamp of the positive cable.

10. A set of lighted booster cables according to claim 1, wherein the lighting device comprises a light emitting diode.

11. A set of lighted booster cables according to claim 1, wherein the ground cable further comprises a lighting device.

12. A set of lighted booster cables according to claim 11, wherein the lighting device is configured to illuminate the second end of the ground cable.

13. A set of lighted booster cables according to claim 12, wherein the lighting device is mounted on the second clamp of the ground cable.

14. A set of lighted booster cables according to claim 13, wherein the lighting device comprises a light emitting diode.

15. A set of lighted booster cables according to claim 14, wherein the lighting device further comprises a switch configured to turn the lighting device on or off.

16. A set of lighted booster cables according to claim 15, wherein the lighting device further comprises an energy source.

17. A set of lighted booster cables according to claim 16, wherein the energy source comprises a battery.

18. A set of lighted booster cables, comprising:
a.) an electrically conductive positive cable having a first end and a second end, wherein the first end of the positive cable further comprises an electrically conductive first clamp, wherein the second end of the positive cable further comprises an electrically conductive second clamp, wherein the first clamp is configured to electrically engage a positive terminal of a source vehicle battery, and the second clamp is configured to electrically engage a positive terminal of a depleted vehicle battery;
b.) an electrically conductive ground cable having a first end and a second end, wherein the first end of the ground cable further comprises an electrically conductive first clamp, wherein the second end of the ground cable further comprises an electrically conductive second clamp, wherein the first clamp is configured to electrically engage a negative terminal of a source vehicle battery, and the second clamp is configured to electrically engage a suitable electrical ground point; and
c.) wherein the ground cable further comprises a lighting device.

19. A set of lighted booster cables according to claim 18, wherein the lighting device is configured to illuminate the second end of the ground cable.

20. A set of lighted booster cables according to claim 19, wherein the lighting device is mounted on the second clamp of the ground cable.

21. A set of lighted booster cables according to claim 20, wherein the lighting device comprises a light emitting diode.

22. A set of lighted booster cables according to claim 21, wherein the lighting device further comprises a switch configured to turn the lighting device on or off.

23. A set of lighted booster cables according to claim 22, wherein the lighting device further comprises an energy source.

24. A set of lighted booster cables according to claim 23, wherein the energy source comprises a battery.

25. A set of lighted booster cables according to claim 24, wherein the ground cable and the positive cable are insulated.

26. A set of lighted booster cables according to claim 19, wherein the lighting device is mounted on the second clamp of the ground cable.

27. A set of lighted booster cables according to claim 19, wherein the lighting device comprises a light emitting diode.

28. A set of lighted booster cables, comprising:
a.) an electrically conductive positive cable having a first end and a second end, wherein the first end of the positive cable further comprises an electrically conductive first clamp, wherein the second end of the positive cable further comprises an electrically conductive second clamp, wherein the first clamp is configured to electrically engage a positive terminal of a source vehicle
b.) battery, and the second clamp is configured to electrically engage a positive terminal of a depleted vehicle battery;
c.) an electrically conductive ground cable having a first end and a second end, wherein the first end of the ground cable further comprises an electrically conductive first clamp, wherein the second end of the ground cable further comprises an electrically conductive second clamp, wherein the first clamp is configured to electrically engage a negative terminal of a source vehicle battery, and the second clamp is configured to electrically engage a suitable electrical ground point;
d.) a means of illumination positioned on a cable selected from the group consisting of the positive cable and the ground cable.

29. A set of lighted booster cables according to claim 28, wherein the means of illumination comprises a light emitting diode.
